(19) United States
(12) Patent Application Publication
(10) Pub. No.: US 2006/0041407 A1
(43) Pub. Date: Feb. 23, 2006

(54) Method for improving the validity level of diagnoses of technical arrangements

(76) Inventors: Diana Estevez Schwarz, Muenchen (DE); Uwe Feldmann, Muenchen (DE)

Correspondence Address: SLATER & MATSIL LLP, 17950 PRESTON ROAD, SUITE 1000, DALLAS, TX, 75252, US

(21) Appl. No.: 11/206,651

(22) Filed: Aug. 18, 2005

(30) Foreign Application Priority Data
Aug. 18, 2004 (DE) 10 2004 040 177.2

(51) Int. Cl. G06F 17/10

(52) U.S. Cl. 703/2

(57) ABSTRACT

The invention, which relates to a method for improving the validity level of diagnoses of technical arrangements, with an equation system that describes the system being produced by a technical arrangement and being tested for structural solvability and singularities, is based on the object of specifying a method that overcomes the problems in the validity level of the previous diagnosis method and that allows even problems that are not purely structural in system designs to be located automatically, this is achieved in that the investigation for singularities is carried out iteratively, with a threshold value for the numerical matrix entries being approximated to a critical value by changing it and redefining it as a function of the result for each new calculation.

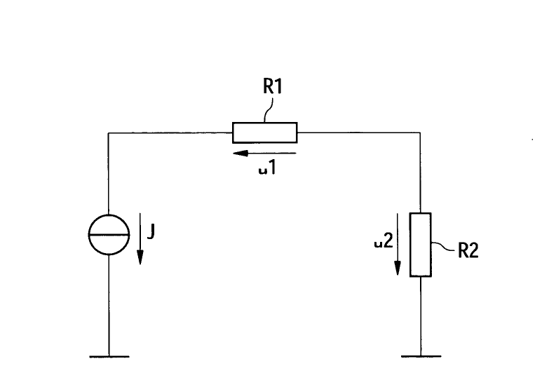

This application claims priority to German Patent Application 10 2004 040 177.2-53, which was filed Aug. 18, 2004, and is incorporated herein by reference.

### TECHNICAL FIELD

The present invention relates generally to simulation methods and in a particular embodiment to methods for improving the validity level of diagnoses of technical arrangements.

### BACKGROUND

The complexity of many modem technical arrangements, in particular with regard to circuitry and microelectronics, requires simulation before their practical implementation. Since exact simulation would be too costly, even with the assistance of computation technology, owing to the enormous complexity of the systems to be described, approximation methods and/or numerical methods are generally used to describe the system. If these methods fail, then diagnosis methods are required, which identify the critical parts of the system.

### SUMMARY OF THE INVENTION

Embodiments of the invention describe methods for improving the validity level of diagnoses of technical arrangements. In one case, an equation system that describes the system is produced by a technical arrangement, and this equation system is calculated on a computer using different parameters. The equation system is tested for structural solvability and for linear dependency in the form of a matrix. In this case, that part of the equation system is determined that causes singularities. If the matrix is structurally regular and simulation problems occur, then numerical values are included in the tests. That part of the technical arrangement that is subject to problems is thus determined, with only the numerical values that are not set to zero in the calculation being those that exceed a defined threshold value.

A method according to embodiments of the invention relates to a diagnosis method that uses such numerical evaluation of a system description. In this case, the behavior of a technical arrangement is described completely in mathematical terms, with this description then being in the form of an equation system. This equation system is then tested for structural solvability. This means that a tree structure, which results from the equation system, is tested in order to determine whether the equation system used for system description can be solved. Expressed in simple terms, this is done by checking whether an independent equation exists for each unknown that describes the system, and if this is not the case the diagnosis method indicates the rows and columns that are linearly dependent on one another.

However, this method indicates only structural problems in a system design, and fails when the solvability of the equation system is dependent on the value of the system parameters, a problem that occurs in particular in the field of non-linear equation systems.

One possible way to identify even this situation is numerical analysis of the system design. In this case, it is within the responsibility of the user to specify a suitable threshold value for taking account of the numerical values. However, this procedure has been found to be extremely subject to gaps since, particularly in non-linear equation systems, the numerical values can fluctuate by several orders of magnitude and it is therefore highly problematic to manually define a suitable threshold value for the numerical diagnosis.

Embodiments of the invention thus specify a method that overcomes the problems with the validity level of the previous method and makes it possible to automatically locate problems in system designs that are not purely structural.

According to embodiments of the invention, advantages are achieved in that the investigation for singularities is carried out iteratively, with the threshold value being approximated to a critical value by changing it and redefining it as a function of the result for each new calculation. The diagnosis information gradually becomes more precise by use of this procedure.

This procedure furthermore avoids the manual definition of a threshold value, and it is possible to determine a threshold value that is located at the boundary between singularity and regularity. The diagnosis results for the optimum threshold value determined in this way allow conclusions to be drawn about the problematic elements of the technical arrangement.

In one particular refinement of the method according to the invention, a first threshold value is reduced when a singularity of the equation system is diagnosed, and a second threshold value is increased when the equation system is regular.

This type of approximation to the critical value in both directions makes it possible to obtain not only the critical value but also further information that contributes to diagnosis of the system design.

In one particular refinement of the method according to the invention, the critical value is reached when the difference between the first and the second threshold value is below a tolerance value.

The introduction of a tolerance value provides the capability to limit the number of iteration steps, and thus to design the method to be as effective as possible.

In one particular refinement of the method according to the invention, the matrix of the equation system is transformed to triangular form before the investigation for singularities.

The application of the diagnosis methods to the triangular form improves the diagnosis level.

In one particular refinement of the method according to the invention, the threshold values are defined and are iteratively adapted for each individual row in the matrix.

In one particular refinement of the method according to the invention, the threshold values are defined and iteratively adapted for each individual column in the matrix.

The two above changes to the method according to the invention make it possible to take account of major scaling differences between the individual rows and columns.

In one particular refinement of the method according to the invention, in the event of a singularity, the only equations of the equation system that are part of the result are those whose residue exceeds a residue threshold value.

If the equation system is identified as being singular, then it is possible to analyze the numerical residues of the numerical equations that cannot be solved. If these residues are sufficiently small, then it can be assumed that the corresponding equation has a regular behavior despite the existence of a residue, so that the relevant equation can be removed from the result list of singular equations.

In one particular refinement of the method according to the invention, in the event of a singularity, the only variables that are part of the result are those whose residual value from the Newton method exceeds a predetermined value.

Particularly in circuitry, where network equations are frequently produced by means of Kirchhoff's Laws, the sum of the currents at a node always being zero, the diagnosis is used for the iteration matrix of the Newton method. If the system is now identified as being singular, then it can nevertheless be assumed that the variables that have been approximated as being sufficiently close to the zero point have a regular behavior despite singularity having been identified. These variables can thus also be removed from the list of critical variables, and the output from the diagnosis method can be sensibly reduced.

In one particular refinement of the method according to the invention, in addition to the diagnosis information, the result also includes those entries in the matrix that remain in the matrix for the highest threshold value that produces regularity.

In one particular refinement of the method according to the invention, in addition to the diagnosis information, the result also includes those entries in the matrix that remain in the matrix for the lowest threshold value that produces singularity.

The two above changes to the method according to the invention allow detailed analysis of the system. Entries in the matrix that are not produced in both cases must be regarded as being particularly critical.

### BRIEF DESCRIPTION OF THE DRAWINGS

The invention will be explained in more detail in the following text with reference to one exemplary embodiment. In the associated drawing:

The FIGURE shows a highly simplified example of a circuit arrangement.

The following list of reference symbols can be used in conjunction with the FIGURE:

| | |
|---|---|
| J | Current source |
| R1 | Resistor |
| R2 | Resistor |
| u1 | Voltage across R1 |
| u2 | Voltage across R2 |

### DETAILED DESCRIPTION OF ILLUSTRATIVE EMBODIMENTS

The circuit arrangement illustrated in the FIGURE is described sufficiently by the following equation system:
αuₗ+εu₂=0
αu₁=1

In this case, the parameters α and ε represent the resistors R1 and R2. The symbols u1 and u2 represent the voltage drops across the respective resistors R1 and R2.

The regularity of the iteration matrix

$$( \begin{matrix}α & ɛ \\ α & 0\end{matrix} )$$

depends on the parameters of the two unknowns x=(u₁,u₂). Let us assume that α=10⁻¹² and ε=10⁻³⁴. The threshold value 10⁻¹⁰, for example, is chosen as the threshold value for a first run through the diagnosis method. Since both α and ε are less than 10⁻¹⁰ and are thus below the threshold value, both are set to zero. The diagnosis method thus considers the matrix:

$$( \begin{matrix}0 & 0 \\ 0 & 0\end{matrix} )$$

In this case, it is immediately evident that this is now an equation system that cannot be solved. The diagnosis method thus produces a singularity as the result and a linear dependency of rows 1 and 2, with both u₁ and u₂ being linearly dependent variables.

The threshold value is now set, for example, to 10⁻⁴⁰ which means that all of the parameters remain in the matrix. The diagnosis method thus considers the matrix:

$$( \begin{matrix}{10}^{- 12} & {10}^{- 34} \\ {10}^{- 12} & 0\end{matrix} )$$

Since the matrix is already in triangular form, the solution can be read easily, and the equation system is regular.

If the threshold value is now raised to 10⁻³⁴, so that α remains in the equation system, while ε is set to zero, then the diagnosis method considers the matrix:

$$( \begin{matrix}{10}^{- 12} & 0 \\ {10}^{- 12} & 0\end{matrix} )$$

In this situation as well, the equation system cannot be solved and is thus singular with the diagnosis showing that rows 1 and 2 depend linearly on one another and that u2 is the linearly dependent variable. This now leads to the conclusion that u₂ is the critical variable, since it causes a singularity for the successive approximated threshold value.

It is thus possible to draw the conclusion for the stated circuit that the voltage u2 is essential for correct operation. However, since the voltage u2 depends directly on the resistor R2, whose magnitude is very small, there is a risk of this not being satisfied in actual conditions, since the resistor R2 does not have a relevant value. The method according to the invention provides the circuit developer with the capability to identify this weakness in the circuit layout in good time and to improve the circuit design, or to reject it.

What is claimed is:

1. A method for improving the validity level of diagnoses of technical arrangements, the method comprising:
producing an equation system that describes a system being designed, the equation system being produced using technical arrangements and being calculated on a computer using different parameters; and
testing the equation system in the form of a matrix for structural solvability and linear dependency, wherein if the matrix is structurally regular and simulation problems nevertheless occur, numerical values are included in structural solvability tests and, in the process, that part of the equation system is determined that causes singularities, and thus that part of the technical arrangement is determined that is subject to the problem, with the only numerical values that are not set to zero being those tjat exceed a defined threshold value, wherein the investigation for singularities is carried out iteratively, with the threshold value being approximated to a critical value by changing it and redefining it as a function of the result for each new calculation.

2. The method as claimed in claim 1, wherein a first threshold value is reduced when a singularity of the equation system is diagnosed, and a second threshold value is increased when the equation system is regular.

3. The method as claimed in claim 1, wherein the critical value is reached when the difference between the first and the second threshold value is below a tolerance value.

4. The method as claimed in claim 1, wherein the matrix of the equation system is transformed to triangular form before the investigation for singularities.

5. The method as claimed in claim 1, wherein the threshold values are defined and are iteratively adapted for each individual row in the matrix.

6. The method as claimed in claim 1, wherein the threshold values are defined and iteratively adapted for each individual column in the matrix.

7. The method as claimed in claim 1, wherein, in the event of a singularity, the only equations that are part of the result are those whose residue exceeds a residue threshold value.

8. The method as claimed in claim 1, wherein, in the event of a singularity, the only variables that are part of the result are those whose residual value from the Newton method exceeds a predetermined value.

9. The method as claimed in claim 1, wherein, in addition to the diagnosis information, the result also includes those entries in the matrix that remain in the matrix for the highest threshold value that produces regularity.

10. The method as claimed in claim 1, wherein, in addition to the diagnosis information, the result also includes those entries in the matrix that remain in the matrix for the lowest threshold value that produces singularity.

11. A method for improving the validity level of diagnoses of technical arrangements, with an equation system that describes the system being produced by the technical arrangements and being calculated on a computer using different parameters, with the equation system being tested in the form of a matrix for structural solvability and linear dependency, and, if the matrix is structurally regular and simulation problems nevertheless occur, numerical values are in this case included in the structural solvability tests and, in the process, that part of the equation system is determined that causes singularities, and thus that part of the technical arrangement is determined that is subject to the problem, with the only numerical values that are not set to zero being those that exceed a defined threshold value, wherein the investigation for singularities is carried out iteratively, with the threshold value being approximated to a critical value by changing it and redefining it as a function of the result for each new calculation.

12. The method as claimed in claim 11, wherein a first threshold value is reduced when a singularity of the equation system is diagnosed, and a second threshold value is increased when the equation system is regular.

13. The method as claimed in claim 11, wherein the critical value is reached when the difference between the first and the second threshold value is below a tolerance value.

14. The method as claimed in claim 11, wherein the matrix of the equation system is transformed to triangular form before the investigation for singularities.

15. The method as claimed in claim 11, wherein the threshold values are defined and are iteratively adapted for each individual row in the matrix.

16. The method as claimed in claim 11, wherein the threshold values are defined and iteratively adapted for each individual column in the matrix.

17. The method as claimed in claim 11, wherein, in the event of a singularity, the only equations that are part of the result are those whose residue exceeds a residue threshold value.

18. The method as claimed in claim 11, wherein, in the event of a singularity, the only variables that are part of the result are those whose residual value from the Newton method exceeds a predetermined value.

19. The method as claimed in claim 11, wherein, in addition to the diagnosis information, the result also includes those entries in the matrix that remain in the matrix for the highest threshold value that produces regularity.

20. The method as claimed in claim 11, wherein, in addition to the diagnosis information, the result also includes those entries in the matrix that remain in the matrix for the lowest threshold value that produces singularity.
